(19) United States
(12) Patent Application Publication
(10) Pub. No.: US 2011/0284661 A1
(43) Pub. Date: Nov. 24, 2011

(54) WATER SAVING DEVICE

(76) Inventors: Chin-Miao CHANG, Taichung City (TW); Hung Shen Chen, Taichung City (TW)

(21) Appl. No.: 12/782,186

(22) Filed: May 18, 2010

(51) Int. Cl. E03C 1/08; B05B 1/30

(52) U.S. Cl. 239/428.5; 239/581.1

(57) ABSTRACT

A water saving device is provided. By a gap defined between a water stopper and a water inlet member of a water guide assembly and a plurality of water discharging portions of the water stopper, the water from the plurality of water discharging portions of the water stopper quickly and stably enters a water guide portion of the water inlet member of the water guide assembly and flows to a net cover through a plurality of water outlet portions of the water inlet member. The gap between the water stopper and the water inlet member of the water guide assembly incorporated with the plurality of water discharging portions of the water stopper guides the water to flow out quickly and stably.

### BACKGROUND OF THE INVENTION

1. Field of the Invention

The present invention relates to a water saving device.

2. Description of the Prior Art

As shown in FIG. 9 and FIG. 10, a conventional water saving comprises a main body (10′), a water guide assembly (20′), a water stopper (30′), and a stop ring (40′). The main body (10′) includes an inner engaging portion (11′) and a locking portion (12′). The water guide assembly (20′) comprises a water inlet member (21′), an engaging ring (22′), and a net cover (23′). The water stopper (30′) has a water outlet (31′). The water inlet member (21′), the engaging ring (22′) and the net cover (23′) of the water guide assembly (20′) are connected in sequence. The water guide assembly (20′) engages with the inner engaging portion (11′) of the main body (10′). The water stopper (30′) is tightly attached to the water inlet member (21′) of the water guide assembly (20′). The stop ring (40′) is disposed at another side of the water inlet member (21′). The locking portion (12′) of the main body (10′) is coupled to a faucet (not shown). The water from the water outlet (31′) of the water stopper (30′) enters the water guide assembly (20′) and then flows out through the water inlet member (21′), the engaging ring (22′) and the net cover (23′). The conventional water saving device has the following shortcomings:

1. Worse stability: the water stopper is tightly attached to the water inlet member of the water guide assembly, and there is no space between the water guide assembly and the water stopper. When the hydraulic pressure is normal, the water from the water outlet of the water stopper quickly and stably enters the water guide assembly to be guided out after being filled to generate a pressure. When the hydraulic pressure is low, the water from the water outlet of the water stopper slowly fills the water inlet member of the water guide assembly. After the water inlet member is filled with the water, the water will be guided out until the pressure is enough. The stability of use is not good.

2. Slow discharge: the water stopper is tightly attached to the water inlet member of the water guide assembly, and there is no space between the water guide assembly and the water stopper. The water inlet member of the water guide assembly must be filled with water so to generate the pressure to guide out the water. The water discharge is slow.

Accordingly, the inventor of the present invention has devoted himself based on his many years of practical experiences to improve the aforesaid problems of the conventional water saving device.

### SUMMARY OF THE INVENTION

The primary object of the present invention is to provide a water saving device. An engaging edge of a water stopper engages with an annular engaging groove of a stop ring. One side of the stop ring is connected to a water inlet member of a water guide assembly. The water inlet member engages with of an engaging ring. The engaging ring engages with a net cover. The net cover is engaged in a main body. By a gap defined between the water stopper and the water inlet member of the water guide assembly and a plurality of water discharging portions of the water stopper, the water from the plurality of water discharging portions of the water stopper quickly and stably enters a water guide portion of the water inlet member of the water guide assembly and flows to the net cover through the plurality of water outlet portions of the water inlet member. The gap between the water stopper and the water inlet member of the water guide assembly incorporated with the plurality of water discharging portions of the water stopper guides the water to flow out quickly and stably.

### BRIEF DESCRIPTION OF THE DRAWINGS

FIG. 1 is a perspective view of the present invention;

FIG. 2 is an exploded view of the present invention;

FIG. 3 is a side cross-sectional view of the present invention;

FIG. 4 is a schematic view the present invention to show the water flow;

FIG. 5 is a schematic view of the present invention when in use;

FIG. 6 is an exploded view according to a first embodiment of the present invention;

FIG. 7 is a side cross-sectional view according to the first embodiment of the present invention;

FIG. 8 is a side cross-sectional view according to a second first embodiment of the present invention;

FIG. 9 is an exploded view of a conventional water saving device; and

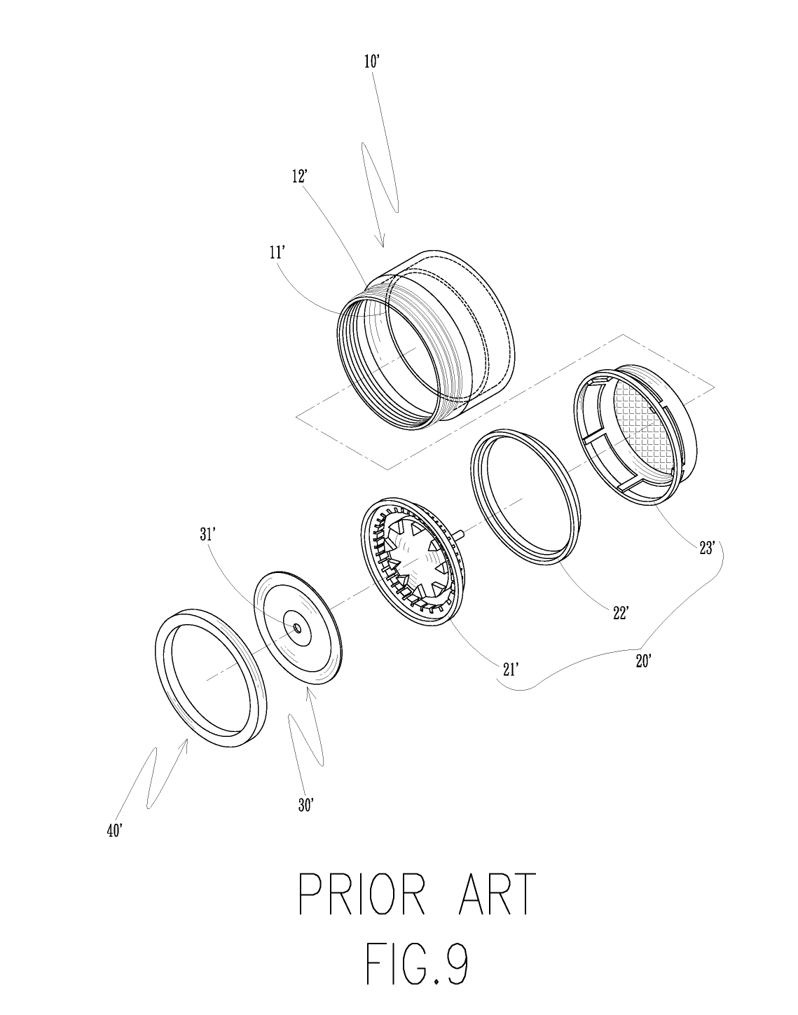

FIG. 10 is a side cross-sectional view of the conventional water saving device.

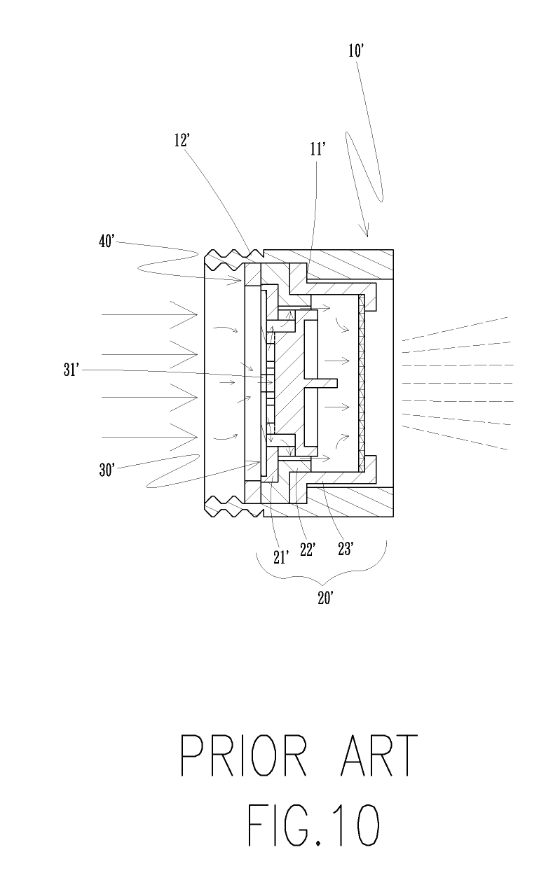

### DETAILED DESCRIPTION OF THE PREFERRED EMBODIMENTS

Embodiments of the present invention will now be described, by way of example only, with reference to the accompanying drawings.

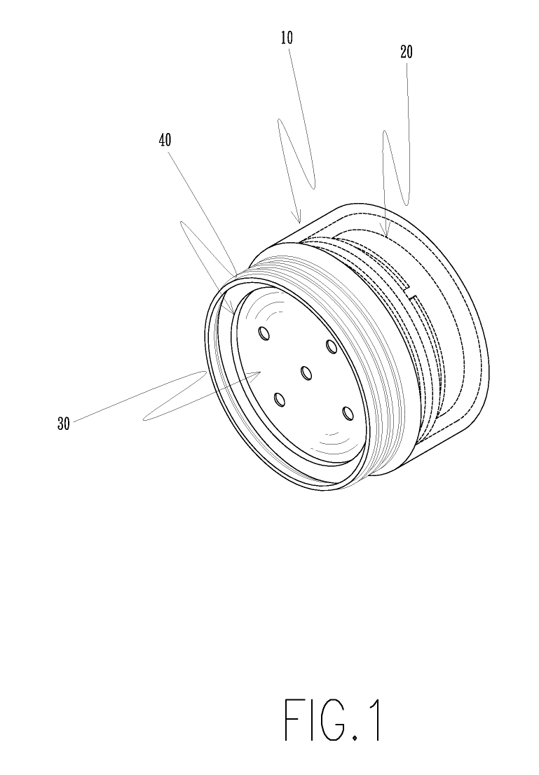

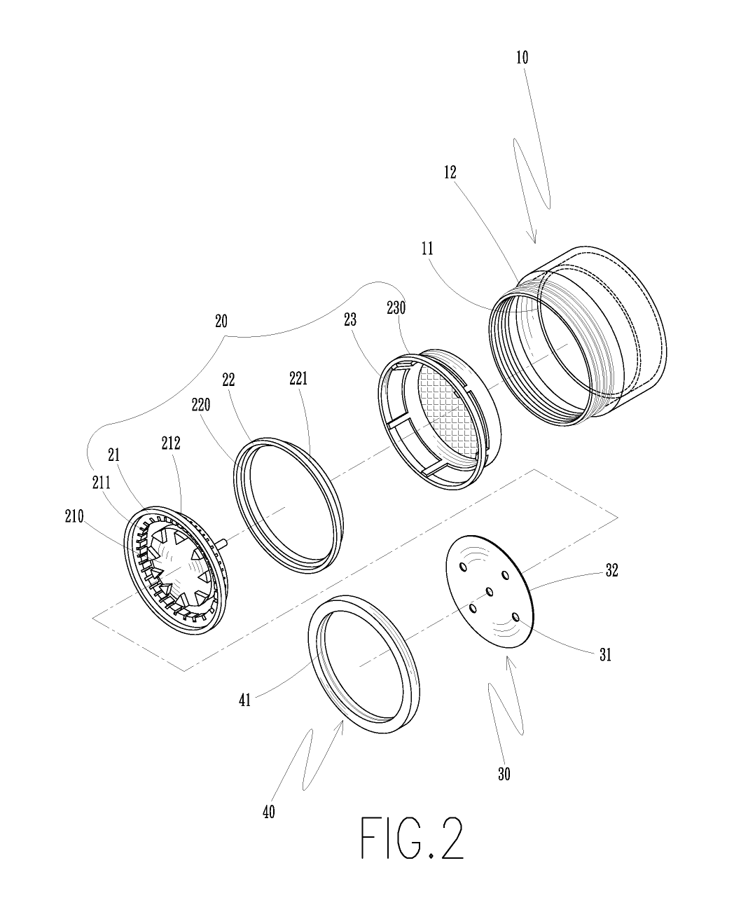

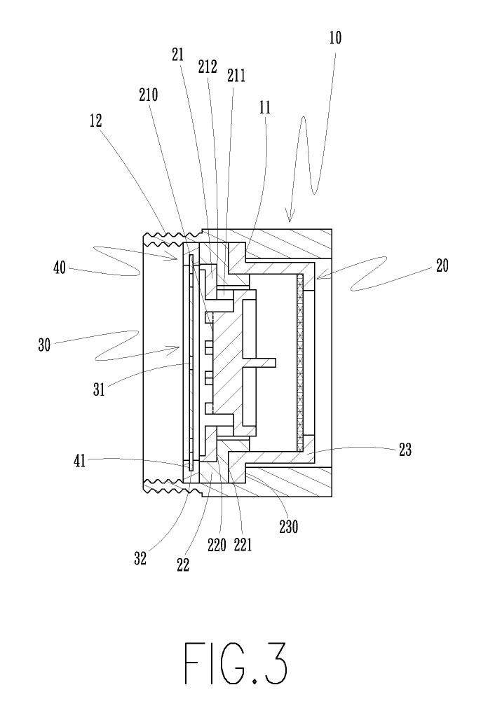

FIG. 1 is a perspective view of the present invention. FIG. 2 is an exploded view of the present invention. FIG. 3 is a side cross-sectional view of the present invention. The water saving device the present invention comprises a main body (10), a water guide assembly (20), a water stopper (30), and a stop ring (40).

The main body (10) includes an inner engaging portion (11) and a locking portion (12).

The water guide assembly (20) comprises a water inlet member (21), an engaging ring (22), and a net cover (23). The water inlet member (21) has a water guide portion (210), a plurality of water outlet portions (211), and an engaging portion (212). The engaging ring (22) has a positioning portion (220) and a limit portion (221). The net cover (23) has a connecting portion (230). The engaging portion (212) of the water inlet member (21) engages with the positioning portion (220) of the engaging ring (22). The limit portion (221) of the engaging ring (22) engages with the connecting portion (230) of the net cover (23). An outer side of the connecting portion (230) of the net cover (23) engages with the inner engaging portion (11) of the main body (10).

The water stopper (30) has a plurality of water discharging portions (31) and an engaging edge (32).

The stop ring (40) has an annular engaging groove (41). The annular engaging groove (41) of the stop ring (40) engages with the engaging ring (32) of the water stopper (30). One side of the stop ring (40) is connected to the water inlet member (21) of the water guide assembly (20). The assembly of the water saving device of the present invention is completed.

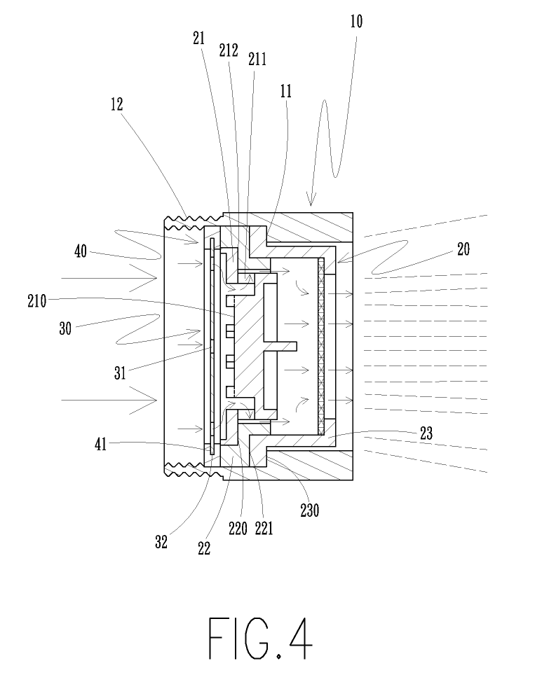

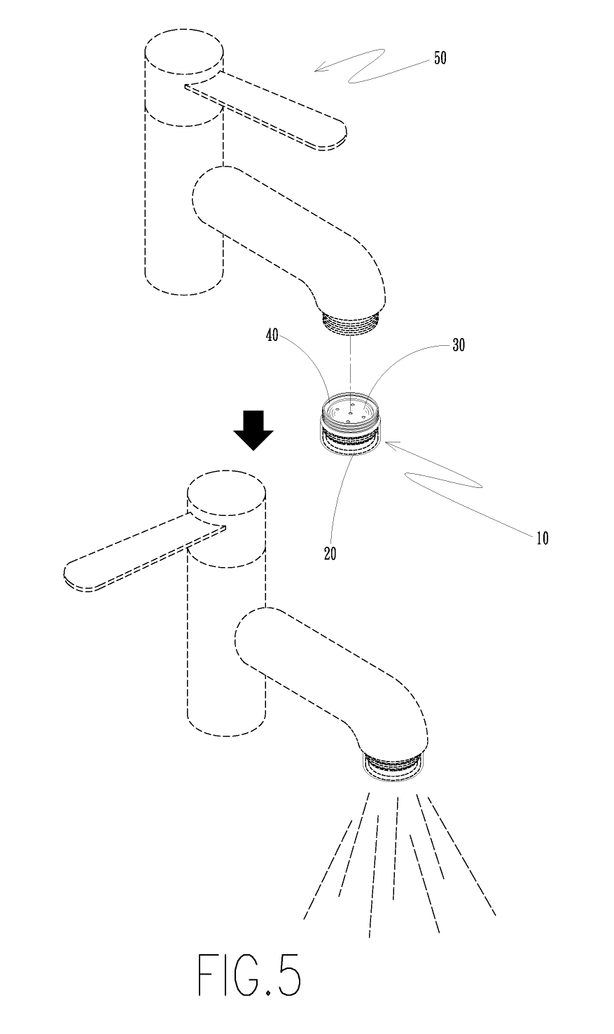

FIG. 4 is a schematic view of the water saving device of the present invention to show the water flow. FIG. 5 is a schematic view of the water saving device of the present invention when in use. The engaging edge (32) of the water stopper (30) engages with the annular engaging groove (41) of the stop ring (40). One side of the stop ring (40) is connected to the water inlet member (21) of the water guide assembly (20). The engaging portion (212) of the water inlet member (21) engages with the positioning portion (220) of the engaging ring (22). The limit portion (221) of the engaging ring (22) engages with the connecting portion (230) of the net cover (23). The outer side of the connecting portion (230) of the net cover (23) engages with the inner engaging portion (11) of the main body (10). The locking portion (12) of the main body (10) is locked to a faucet (50). There is a gap defined between the water stopper (30) and the water inlet member (21) of the water guide assembly (20). When the high hydraulic pressure is about 60 PSI, the gap will limit the water yield smaller than 1.5 GPM. The water stopper (30) has the plurality of water discharging portions (31). When the low hydraulic pressure is about 20 PSI, the water flows out from the plurality of water discharging portions (31) to achieve the water yield greater than 0.8 GPM, such that the water from the plurality of water discharging portions (31) of the water stopper (30) quickly and stably enters the water guide portion (210) of the water inlet member (21) of the water guide assembly (20) and flows to the net cover (23) through the plurality of water outlet portions (211) of the water inlet member (21).

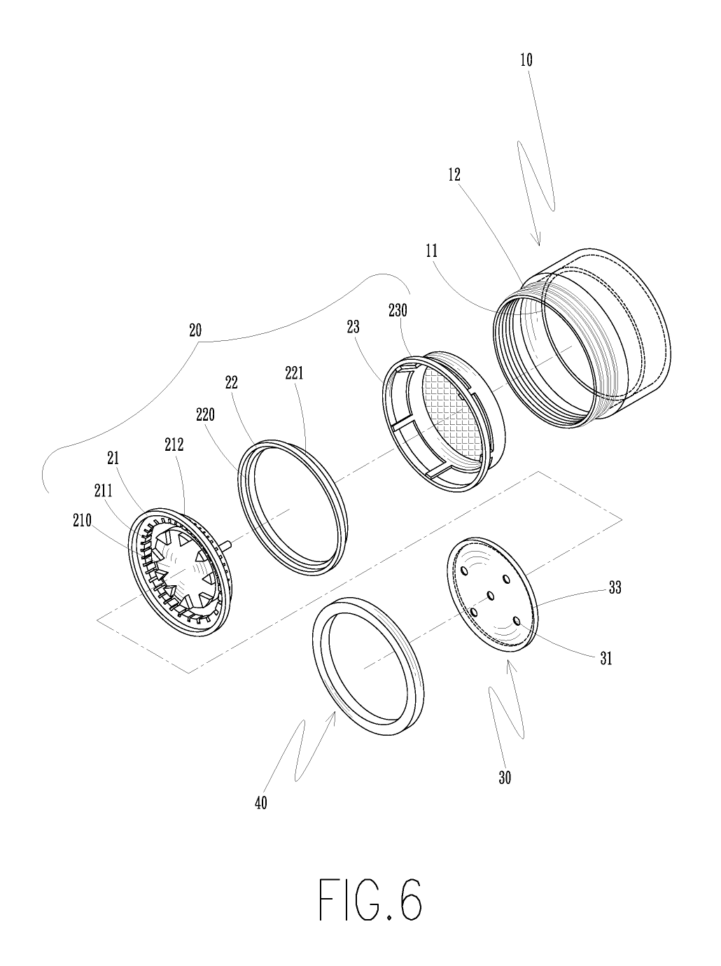

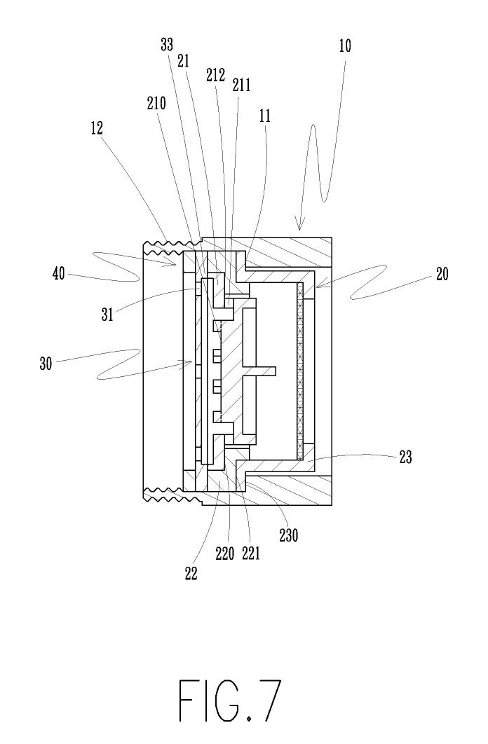

FIG. 6 is an exploded view of the water saving device according to a first embodiment of the present invention. FIG. 7 is a side cross-sectional view of the water saving device according to the first embodiment of the present invention. The first embodiment is substantially similar to the structure as shown in FIG. 1 to FIG. 3 with the exceptions described hereinafter. The water stopper (30) has a protruding top portion (33). The protruding top portion (33) of the water stopper (30) engages with a top end of the water inlet member (21) of the water guide assembly (20). One side of the stop ring (40) is connected to a top outer edge of the water stopper (30). The engaging portion (212) of the water inlet member (21) engages with the positioning portion (220) of the engaging ring (22). The limit portion (221) of the engaging ring (22) engages with the connecting portion (230) of the net cover (23). The outer side of the connecting portion (230) of the net cover (23) engages with the inner engaging portion (11) of the main body (10). The locking portion (12) of the main body (10) is locked to the faucet (50). There is a gap defined between the water stopper (30) and the water inlet member (21) of the water guide assembly (20). When the high hydraulic pressure is about 60 PSI, the gap will limit the water yield smaller than 1.5 GPM. The water stopper (30) has the plurality of water discharging portions (31). When the low hydraulic pressure is about 20 PSI, the water flows out from the plurality of water discharging portions (31) to achieve the water yield greater than 0.8 GPM, such that the water from the plurality of water discharging portions (31) of the water stopper (30) quickly and stably enters the water guide portion (210) of the water inlet member (21) of the water guide assembly (20) and flows to the net cover (23) through the plurality of water outlet portions (211) of the water inlet member (21).

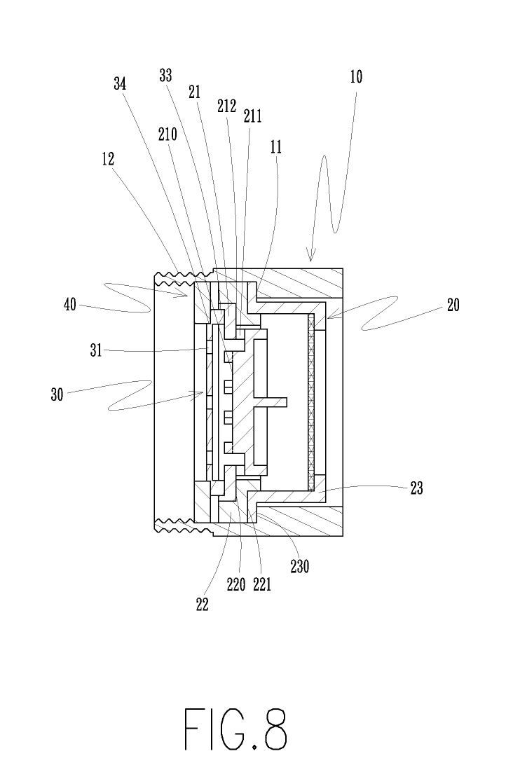

FIG. 8 is a side cross-sectional view of the water saving device according to a second embodiment of the present invention, which is substantially similar to the structure as shown in FIG. 1 to FIG. 3 with the exceptions described hereinafter. The water stopper (30) has the protruding top portion (33) and an annular positioning portion (34). The protruding top portion (33) of the water stopper (30) engages with the top end of the water inlet member (21) of the water guide assembly (20). An inner edge of the stop ring (40) engages with the annular positioning portion (34) of the water stopper (30). The engaging portion (212) of the water inlet member (21) engages with the positioning portion (220) of the engaging ring (22). The limit portion (221) of the engaging ring (22) engages with the connecting portion (230) of the net cover (23). The outer side of the connecting portion (230) of the net cover (23) engages with the inner engaging portion (11) of the main body (10). The locking portion (12) of the main body (10) is locked to the faucet (50). With the protruding top portion (33) of the water stopper (30), there is a gap formed between the water stopper (30) and the water inlet member (21) of the water guide assembly (20). When the high hydraulic pressure is about 60 PSI, the gap will limit the water yield smaller than 1.5 GPM. The water stopper (30) has the plurality of water discharging portions (31). When the low hydraulic pressure is about 20 PSI, the water flows out from the plurality of water discharging portions (31) to achieve the water yield greater than 0.8 GPM, such that the water from the plurality of water discharging portions (31) of the water stopper (30) quickly and stably enters the water guide portion (210) of the water inlet member (21) of the water guide assembly (20) and flows to the net cover (23) through the plurality of water outlet portions (211) of the water inlet member (21).

The advantages of the present invention are as follows:

1. Better stability: there is a gap defined between the water stopper and the water inlet member of the water guide assembly and the water stopper has the plurality of water discharging portions, such that the water from the plurality of water discharging portions of the water stopper quickly and stably enters the water guide portion of the water inlet member of the water guide assembly. The water flow won't be influenced by the hydraulic pressure.

2. Quick discharge: there is a gap defined between the water stopper and the water inlet member of the water guide assembly and the water stopper has the plurality of water discharging portions, such that the water from the plurality of water discharging portions of the water stopper quickly and stably enters the water guide portion of the water inlet member of the water guide assembly and flows to the net cover through the plurality of water outlet portions of the water inlet member. The gap between the water stopper and the water inlet member of the water guide assembly incorporated with the plurality of water discharging portions of the water stopper guides the water to flow out quickly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A water saving device, comprising:
a main body, the main body including an inner engaging portion and a locking portion;
a water guide assembly, the water guide assembly comprising a water inlet member, an engaging ring and a net cover, the water inlet member having a water guide portion and a plurality of water outlet portions, the water inlet member engaging with the engaging ring, the engaging ring engaging with the net cover, an outer side of the net cover engaging with the inner engaging portion of the main body;
a water stopper, the water stopper having a plurality of water discharging portions and an engaging edge; and
a stop ring, the stop ring having an annular engaging groove, the annular engaging groove of the stop ring engaging with the engaging ring of the water stopper, one side of the stop ring being connected to the water inlet member of the water guide assembly.

2. The water saving device as claimed in claim 1, wherein the water inlet member has an engaging portion, the engaging ring has a positioning portion, and the engaging portion of the water inlet member engages with the positioning portion of the engaging ring.

3. The water saving device as claimed in claim 1, wherein the engaging ring has a limit portion, the net cover has a connecting portion, and the limit portion of the engaging ring engages with the connecting portion of the net cover.

4. A water saving device, comprising:
a main body, the main body including an inner engaging portion and a locking portion;
a water guide assembly, the water guide assembly comprising a water inlet member, an engaging ring and a net cover, the water inlet member having a water guide portion and a plurality of water outlet portions, the water inlet member engaging with the engaging ring, the engaging ring engaging with the net cover, an outer side of the net cover engaging with the inner engaging portion of the main body;
a water stopper, the water stopper having a plurality of water discharging portions and a protruding top portion, the protruding top portion engaging with a top end of the water inlet member of the water guide assembly; and
a stop ring, one side of the stop ring being connected to a top outer edge of the water stopper.

5. The water saving device as claimed in claim 4, wherein the water inlet member has an engaging portion, the engaging ring has a positioning portion, and the engaging portion of the water inlet member engages with the positioning portion of the engaging ring.

6. The water saving device as claimed in claim 4, wherein the engaging ring has a limit portion, the net cover has a connecting portion, and the limit portion of the engaging ring engages with the connecting portion of the net cover.

7. The water saving device as claimed in claim 4, wherein the water stopper has an annular positioning portion and the annular positioning portion engages with an inner edge of the stop ring.
